(19) United States
(12) Patent Application Publication
(10) Pub. No.: US 2026/0021792 A1
(43) Pub. Date: Jan. 22, 2026

(54) FAIRED WINDSCREEN WIPER BLADE

(71) Applicant: VALEO SYSTEMES D'ESSUYAGE, La Verriere (FR)

(72) Inventors: Nathalie LALOI, La Verriere (FR); Guillaume BARRET, La Verriere (FR)

(73) Assignee: VALEO SYSTEMES D'ESSUYAGE, La Verriere (FR)

(21) Appl. No.: 18/993,642

(22) PCT Filed: Jun. 26, 2023
(86) PCT No.: PCT/EP2023/067240

§ 371 Date: Jan. 13, 2025

(30) Foreign Application Priority Data
Jul. 13, 2022 (FR) 2207209

(51) Int. Cl. B60S 1/38

(52) U.S. Cl. CPC B60S 1/3887; B60S 1/3856

(57) ABSTRACT

A windshield wiper for a vehicle. The windshield wiper includes a cowl with a central mount and at least one end cap disposed in the continuation of the central mount and at least one yoke mounted in pivotable articulation with the central mount. The at least one end cap being pivotably articulated on the at least one yoke.

### TECHNICAL FIELD

The invention relates to a cowled windshield wiper for a motor vehicle, and to a wiping system comprising such a wiper.

### BACKGROUND OF THE INVENTION

In windshield wipers for vehicles, it is becoming increasingly desirable to incorporate an aerodynamic aspect in the windshield wiper, insofar as the aerodynamic elements constitute a major part of the structure of the windshield wiper. Such windshield wipers are commonly referred to as “hybrid” windshield wipers.

Such an aerodynamic aspect has a certain number of advantages, notably that of reducing the drag force exerted by the flow of air incident on the windshield wiper. The aerodynamic shape can also be configured to generate a normal force on the windshield wiper when the air passes across it, pressing the windshield wiper against the windshield and improving the wiping performance. The profiled shape also has a more esthetic appearance than a windshield wiper configured in the more traditional style of yokes at multiple levels.

In “hybrid” windshield wipers, the aerodynamic aspect is implemented in the form of a rigid cowl which forms part of the structure of the windshield wiper. The cowl generally comprises multiple individual components, which are articulated to one another so as to allow the windshield wiper to bend and follow the curvature of the windshield when the windshield wiper passes over it. In addition, and depending on the length of the wiper, the windshield wiper may comprise a single level of yokes (sometimes also referred to as “clamps”) which are articulated to the cowl and retain the rubber squeegee blade, in order to more uniformly distribute the force exerted by the wiper arm over the length of the wiper.

In this way, the cowl constitutes a major part of the structure of the windshield wiper, thereby simplifying its construction.

Given that the central mount and the end caps are rigid elements, and that the windshield wiper must be able to bend to follow the curvature of the windshield, it is necessary to provide a type of articulation means which allows the end caps to pivot relative to the central mount. In particular, given that the windshield wiper must follow the curvature of the windshield while still maintaining a high degree of wiping performance along its entire trajectory, the articulation of the end caps on the central mount should allow free rotation about a transverse axis, but be rigid and robust in all the other directions and about all the other axes.

It is known to establish a direct articulation between the central mount and the end caps, such as in the French patent application FR 3 023 805, which discloses an articulation comprising a finger which extends from the central mount and is received and retained pivotably in a corresponding structure of the end cap.

Such a configuration is disadvantageous in that the rigidity of the elements of the cowl can prevent the wiper from properly following the surface of the windshield on which it is used. More specifically, a rigid cowl combined with a single articulation in rotation will reduce the ability of the wiper to follow the curved surface of the windshield. Moreover, the rigid and uniaxial articulation of the end cap on the central mount has a non-optimum visual appearance. Finally, it would furthermore be advantageous to provide a windshield wiper with a cowl which can be mounted easily, so as to minimize breakage of the articulation during the mounting and during use of the wiper.

The invention of the present application aims to address at least one of these disadvantages.

### SUMMARY OF THE INVENTION

Consequently, and according to a first aspect, the invention provides a windshield wiper, in particular for a vehicle, comprising a cowl comprising a central mount and at least one end cap disposed in the continuation of said central mount.

According to the invention, the at least one end cap is pivotably articulated on the at least one yoke.

The articulation of the end cap on the yoke, rather than directly on the central mount, will afford a configuration in which the end cap can move not only in rotation relative to the central mount, but also in translation.

More specifically, the articulation point of the end cap is itself situated on a rotatable element; the yoke is articulated in rotation on the central mount, and the end cap is mounted at a distance from the pivot axis of said yoke.

Consequently, the end cap is provided with increased mobility relative to the central mount, while still preserving a rigidity and robustness of the connection between the elements of the cowl outside of the articulation axes. A wiper configured in this way can therefore more closely conform to the surface that it wipes, while still preserving a high level of mechanical robustness.

The wiper may also comprise one or more of the following optional aspects, which can be combined freely depending on the needs of the implementation in question.

Advantageously, the at least one yoke comprises a central core, two lateral flanks extending from opposite edges of said central core and at least one pair of claws at a longitudinal end of said at least one yoke.

The yoke configured in this way is both robust and inexpensive to manufacture, thus affording the advantages of the invention without adding excessive additional cost or complexity.

Advantageously, the at least one yoke comprises at least one articulation bore formed in at least one of the two lateral flanks of said yoke.

With preference, the at least one end cap comprises two articulation pads extending top-to-tail from a lower surface of said at least one end cap so as to form an articulation axis, said articulation pads being push-fitted into the at least one articulation bore of the yoke.

Such a configuration is particularly advantageous in that it affords an articulation between the end cap and the central mount that is both easy to construct and easy to mount.

In one embodiment, the yoke has a narrowing at certain points of the at least one yoke at the articulation of said end cap on said yoke, said narrowing extending from the at least one articulation bore to the central core of said yoke.

Such a wiper is advantageous in that the presence of the at least one narrowing enables extremely easy articulated mounting of the end cap. In particular, the narrowing makes it possible to mount the articulation of the end cap in the corresponding articulation bore on the yoke in a way which reduces the force that must be exerted and/or the deformation that must be applied to the end cap during the mounting operation necessary for mounting it on the yoke.

Advantageously, the at least one narrowing is at least partially formed by at least one mounting surface formed in the yoke, said at least one mounting surface being inclined toward a midplane of the yoke.

Such a configuration is particularly advantageous in that, by providing this inclined planar surface, the end cap can be mounted on the yoke progressively and easily. The assembly force and the mechanical stresses to which the end cap is subjected during the mounting are similarly reduced.

With preference, each at least one mounting surface is bordered by at least two guide surfaces, said at least one mounting surface and the at least two guide surfaces together forming a channel, said at least two guide surfaces preferably being substantially planar.

With preference, the channel extends from the articulation bores to the central core of the yoke.

Such a configuration is particularly advantageous in that the provision of the at least one guide surface will facilitate the articulated mounting of the end cap on the yoke, by permitting a slight misalignment between the component parts. During an articulation operation, the one or more guide surfaces will lead the articulation pads toward the bores by means of the sliding contact between them.

In one possible configuration, the at least one narrowing is inclined at an angle ranging between 5 and 20 degrees, preferably between 10 and 15 degrees, and more preferably of 13 degrees, in relation to the longitudinal midplane of the yoke.

The orientation of the at least one narrowing thus affords an optimum balance between compactness and ease of mounting.

According to a second aspect, the invention comprises a wiping system according to the description above.

### BRIEF DESCRIPTION OF DRAWINGS

These aspects, features and advantages of the invention, as well as others, will be easily appreciated in the light of the appended figures, in which:

FIG. 1 is a perspective view of a windshield wiper according to a first embodiment of the invention;

FIG. 2 is a detail view of the windshield wiper according to FIG. 1;

FIG. 3 is an exploded view of the windshield wiper according to FIG. 1;

FIG. 4 is a perspective view of a windshield wiper according to a second embodiment of the invention;

FIG. 5A is a sectional view of the windshield wiper according to FIG. 1;

FIG. 5B is a sectional view of the windshield wiper according to FIG. 4; and

FIG. 6 is a graph illustrating the assembly force exerted on the windshield wipers according to FIG. 1 and FIG. 4.

### DETAILED DESCRIPTION OF THE INVENTION

The invention will be better understood in the context of the figures and in the light of the following discussion.

To make it easier to understand the figures in relation to the following description, it should firstly be noted that, in some of the figures, one or more axes are illustrated. More specifically, it will be noted that these axes follow the overall direction of the windshield wiper: they will thus be understood as being a longitudinal axis which follows the length of the wiper; a transverse axis perpendicular to said longitudinal axis in a direction parallel to the surface of a windshield on which the wiper is placed; and a vertical axis perpendicular to said longitudinal axis and to said windshield surface.

In addition, when relative terms such as “upper” and “lower” are used, it will be understood that these terms are used with reference to the wiper when it is positioned with the rubber windshield wiper on a horizontal plane, the terms “upper” and “lower” being in particular used with reference to gravitational force in the usual way.

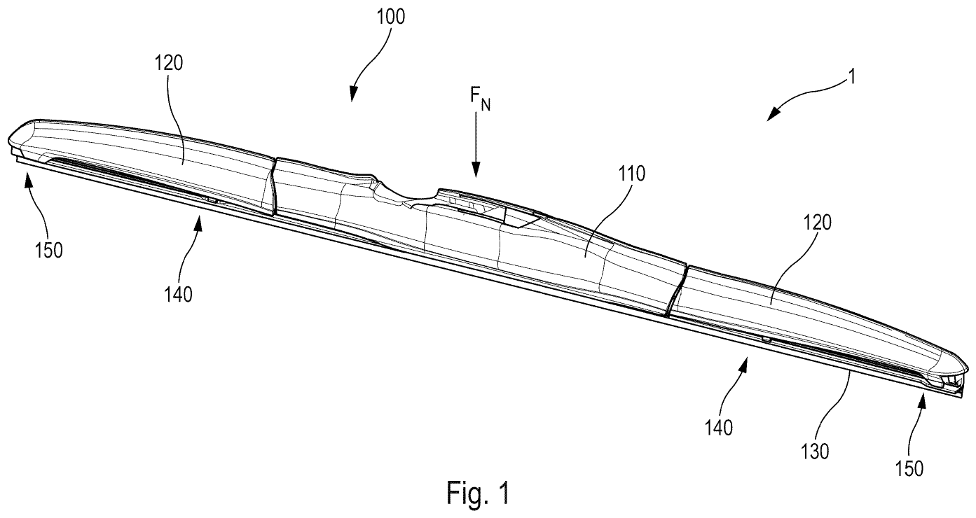

FIG. 1 illustrates a windshield wiper 1 for a vehicle according to a first embodiment of the invention, with a cowl 100 comprising a central mount 110 and two end caps 120. The two end caps 120 are each articulated on the central mount 110, in the longitudinal continuation thereof, by way of pivotable articulations which will be described in more detail below.

The windshield wiper 1 also comprises a wiper blade 130, which is held in place in the windshield wiper 1 by yokes 140 and claws 145 and 150; a first pair of claws 145 being borne by the ends of the yokes 140 and a second pair of claws 150 being integrally formed by the end cap 120. The yokes 140 (partially visible in FIG. 1 but illustrated in more detail by the following figures) are arched structures comprising, at the ends thereof, claws which are intended for retaining the wiper blade 130 and are pivotably articulated on the central mount 110 of the windshield wiper 1.

These yokes 140 serve to distribute the normal force FN exerted on the windshield wiper 1 by an arm of a wiping system of a vehicle (not illustrated) over the entire length of the wiper 1, in order to ensure effective wiping and closer following of the curved shape of the windshield. In conjunction with the claws 150, the yokes also serve to retain the wiper blade 130 in the windshield wiper 1.

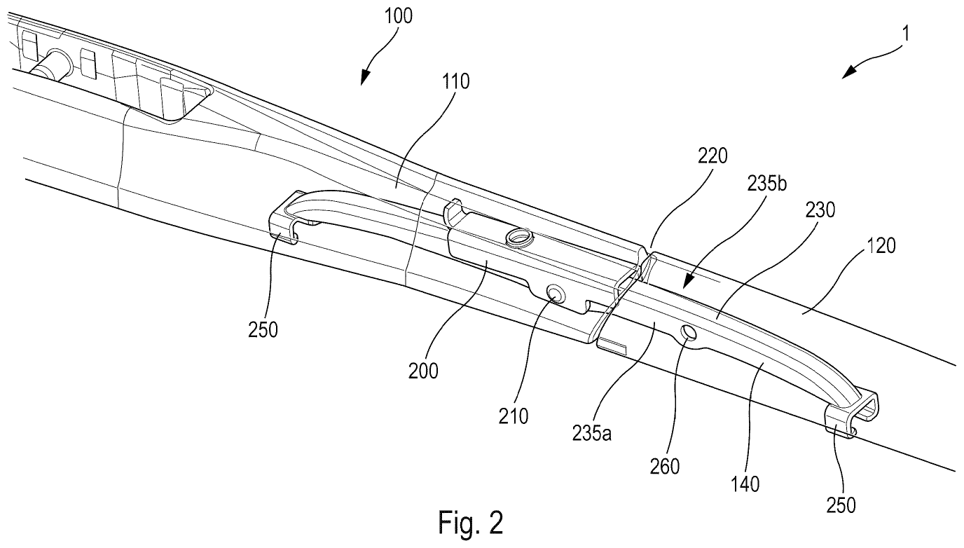

FIG. 2 illustrates the windshield wiper 1 of FIG. 1 in more detail. In FIG. 2, the central mount 110 and one of the end caps 120 are illustrated as see-through in order to be able to illustrate the configuration and mounting of the articulations therein better.

More specifically, the articulation between the central mount 110 and the yoke 140 is effected by means of an adapter element 200. The adapter element 200 is attached on the inside of the central mount 110 and serves to provide a structure on which the yoke 140 can be mounted in articulation with the central mount 110, at the articulation pin 210.

However, it will be appreciated that, in another embodiment, it would be possible for the wiper 1 to not comprise an adapter element, the yoke 140 then being articulated directly with the central mount 110 or, alternatively, with another yoke. The invention of the present application would apply just as well to these embodiments different than the one presented here.

The yoke 140 extends beyond a longitudinal end 220 of the central mount 110. The yoke 140 has the overall form of two arms extending on either side of the articulation pin 210 and is made up of a central core 230 and two lateral flanks 235a, 235b each extending from two opposite lateral edges of said central core 230. At each end of the yoke 140, there is a pair of claws 250 which retain the wiper blade.

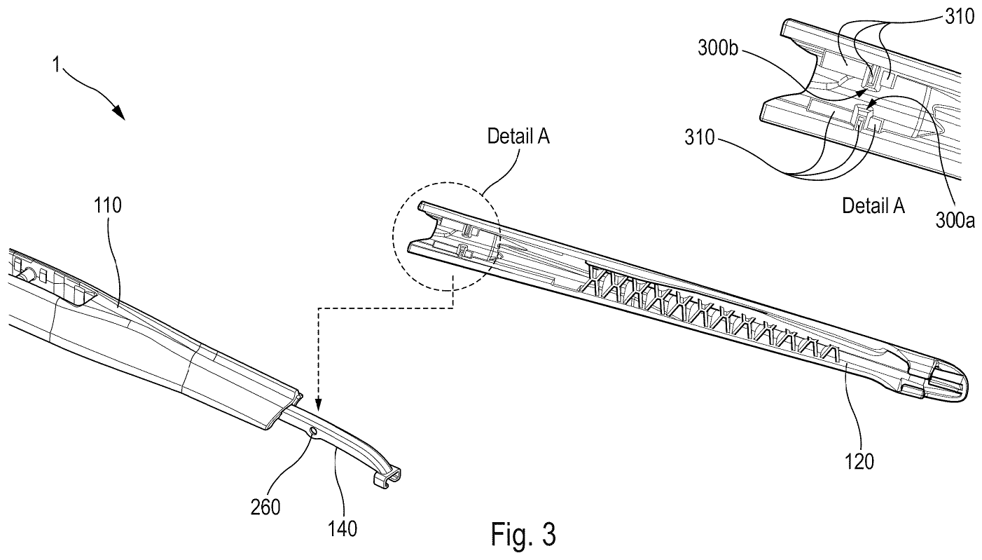

Provided in each lateral flank 235a, 235b of the yoke 140 is an articulation bore 260, one of which is illustrated in FIG. 2. The articulation bore 260 serves to provide an attachment point for the articulated mounting of the end cap 120 on the yoke 140, as described below with respect to FIG. 3.

In the embodiment illustrated in FIG. 2, the articulation bore 260 is a hole formed in the lateral flank 235a. The articulation bore 260 is substantially cylindrical and a through-bore; other configurations, e.g. a blind hole and/or tapped hole, could readily be envisaged.

FIG. 3 illustrates, in more detail, the articulated mounting of the end cap 120 on the yoke 140, and in particular the structures on the end cap 120 which make it possible to mount it on the yoke 140. More specifically, FIG. 3 shows a partially exploded view, with the end cap 120 de-articulated from the yoke 140 and turned over to expose its lower side. In order to better illustrate the articulation structures, FIG. 3 also comprises a view of a detail, detail A, depicted as an inset.

The end cap 120 comprises a pair of articulation pads 300a, 300b, which are formed integrally with the end cap 120 and extend top-to-tail from the lower surface of the end cap 120, as illustrated in FIG. 3. The two articulation pads 300a, 300b are push-fitted into the articulation bores 260. The end cap 120 has a substantially U-shaped cross section and is preferably manufactured from a resilient material; the elasticity of the end cap 120 thus enables the articulated mounting thereof and ensures the retention of the articulation pads 300a, 300b in the articulation bores 260.

Optionally but advantageously, the articulation pads 300a, 300b could also comprise stabilizing pads 310. The stabilizing pads 310 are formed integrally with the end cap 120 and the articulation pads 300a, 300b, and extend from the articulation pads 300a, 300b, substantially in the longitudinal and vertical directions. The stabilizing pads 310 are configured to closely follow the shapes of the lateral flanks 235a, 235b of the yoke 140 when the end cap 120 is mounted in articulation on the yoke 140. This configuration thus affords a better lateral rigidity along the transverse axis of the windshield wiper 1 and a better resistance to twisting about the longitudinal axis of the wiper 1.

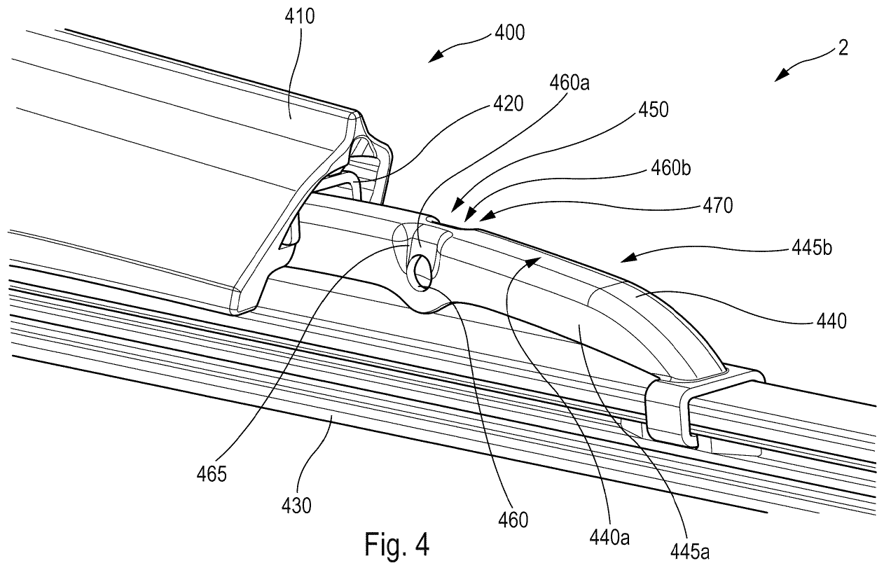

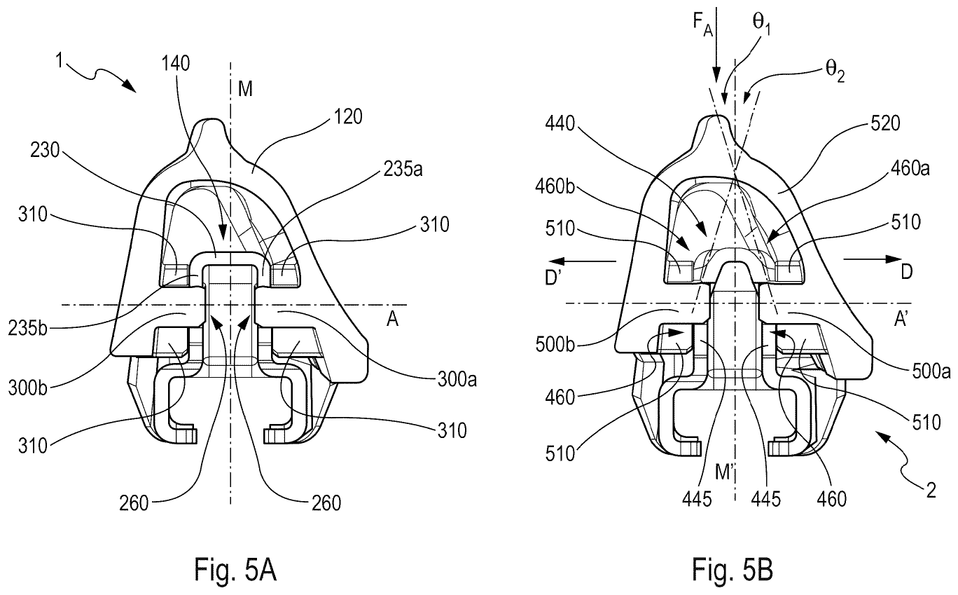

FIG. 4 presents a windshield wiper 2, according to a second embodiment of the invention. It will be evident that the windshield wiper 2 in FIG. 4 is similar to the windshield wiper 1 in FIG. 1 to FIG. 3, notably in that it comprises a cowl 400 comprising a central mount 410 and at least one end cap (not illustrated in FIG. 4, but visible in FIG. 5B and provided with the reference number 520). The wiper 2 also comprises an adapter element 420, on which a yoke 440 which retains a wiper blade 430 is mounted in pivotable articulation, in the same way as the windshield wiper 1 in FIG. 1 to FIG. 3.

The windshield wiper 2 differs from that in the preceding figures in that it has a narrowing 450 on one of the branches of the yoke 440, at the articulation bore 460.

The narrowing 450 is in this case made up of two mounting surfaces 460a, 460b, which are formed in the lateral faces 445a, 445b of the yoke 440 and extend from the corresponding articulation bore 460 to the central core 440a of the yoke 440, as illustrated in FIG. 4.

The presence of at least one mounting surface 460a, 460b therefore constitutes said narrowing of the yoke 440 at the articulation bore 460.

The yoke 440 additionally comprises at least one guide surface, one of which, the guide surface 465, is illustrated for the sake of clarity. With preference, each guide surface 465 is substantially tangential to the articulation bore 460 from which it extends. The guide surfaces 465 are in this case substantially planar, but can also be concave or convex depending on the needs of the implementation in question.

The mounting surface 460a, 460b is thus delimited downwardly by the articulation bore 460, upwardly by the central core 440a of the yoke 440, and to the sides by at least one guide surface 465. In the embodiment illustrated in FIG. 4, each mounting surface 460a, 460b is bordered by two guide surfaces 465; the combination of a mounting surface 460a, 460b and its guide surfaces 465 together forming a channel 470.

Advantageously, the guide surfaces 465 are also inclined, such that the channel 470 is wider at the central core 440a than at the articulation bore 460, the channel thus taking the form of a funnel. This funnel form makes it easier to mount the end cap on the yoke 440, in that it enables a slight misalignment of the articulation pads of the end cap along the longitudinal axis of the windshield wiper 2.

FIG. 5A and FIG. 5B are cross-sectional views of the windshield wipers 1 and 2, respectively, taken at the articulation bores 260 and 460, respectively.

FIG. 5A shows how the articulation pads 300a, 300b, extending along the articulation axis A, are push-fitted into the articulation bores 260. It will be noted in particular how the lateral flanks 235a, 235b are perpendicular to the central core 230 of the yoke 140 and substantially parallel to the midplane M of the windshield wiper 1. It will also be noted how the stabilizing pads 310 closely follow the shape of the lateral flanks 235a, 235b, thus stabilizing the articulation of the end cap 120 on the yoke 140.

To mount the end cap 120 on the yoke 140, all that needs to be done is move the two sides of the end cap 120 far enough away from one another to allow the articulation pads 300a, 300b to pass the central core 230 of the yoke. Then, the end cap 120 is moved forward onto the yoke 140 until the articulation pads 300a, 300b can be received in the articulation bores 260, the elasticity of the end cap 120 allowing it to return to its initial shape and causing the articulation pads 300a, 300b to be retained in the articulation bores 260.

FIG. 5B also shows the articulation pads 500a, 500b, which extend from the end cap 520 and together define the articulation axis A′. Like in the windshield wiper 1 in FIG. 5A, the articulation pads 500a, 500b extend from the lower surface of the end cap and are push-fitted into the articulation bores 460, and the stabilizing pads 510 closely follow the shape of the lateral flanks 445a, 445b of the yoke 440.

To articulate the end cap 520 on the yoke 440, the two articulation pads 500a, 500b are positioned on the central core of the yoke 440, at the top edge of the mounting surfaces 460a, 460b. An assembly force is then applied FA and forces the articulation pads 500a, 500b against the mounting surfaces 460a, 460b.

As indicated in FIG. 5B, the mounting surfaces 460a, 460b are inclined relative to the midplane M′ of the windshield wiper 2. When the assembly force FA is applied to the end cap 520, this inclination of the mounting surfaces 460a, 460b has the effect of pushing back the corresponding articulation pads 500a, 500b; the two sides of the end cap 520 are thus moved away from one another, along the directions D and D′, as illustrated in FIG. 5B.

Progressively, and under the impetus of the assembly force FA, the articulation pads 500a, 500b move forward on the mounting surfaces 560a, 560b toward the articulation bores 460. At the end of their travel, the articulation pads are push-fitted into the articulation bores 460 and the elasticity of the end cap 520 causes them to be held in place as illustrated in FIG. 5B.

It should be noted that, like for the windshield wiper 1 in FIG. 5A, moving the two sides of the end cap 520 away from one another will generate a deformation, and therefore a mechanical stress, in the body of the end cap 520; the more the end cap has to move apart, the greater this stress will be.

The provision of a narrowing in the yoke 440 associated with the articulation bores, such as the two mounting surfaces 460a, 460b shown in FIG. 4 and FIG. 5B, is particularly advantageous in that, in addition to the already-discussed advantages of the invention, the initial movement apart (at the moment the assembly force FA starts to be applied and the articulation pads 500a, 500b start to move forward on the mounting surfaces 460a, 460b) will be reduced relative to a configuration in which the yoke does not comprise a narrowing. In addition, the presence of the mounting surfaces 460a, 460b makes it possible to better control the stresses generated in the end cap during its articulated mounting, in that the movement apart of the end cap is both lesser and applied more progressively.

In addition, this reduction in stresses during the articulated mounting of the end cap 520 makes it possible to make it more rigid than would be possible if the lateral flanks of the yoke are orthogonal to the central core. This affords a better retention of the end cap on the windshield wiper, in particular under extreme use conditions such as in freezing conditions or in an automatic car wash.

It can be seen more particularly that the mounting surfaces 460a, 460b are inclined relative to the midplane M′ by an angle θ1, θ2, thus forming a narrowing at certain points of the yoke 440. FIG. 5B shows that the angles θ1, θ2 are identical, and that the mounting surfaces 460a, 460b are planar, thereby affording a substantially progressive and linear deformation of the end cap 520 until the articulation pads 500a, 500b have been properly push-fitted in the articulation bores 460 as illustrated.

As an alternative, choosing asymmetrical angles θ1, θ2 would make it possible to promote the movement apart of the cap on one of the two sides, such that the deformation along the direction D is greater than the deformation along the direction D′, or vice versa. It would also be conceivable for one of the or both mounting surfaces 460a, 460b to be curved (instead of planar, as illustrated in FIG. 5B) in order to afford a non-linear progression of deformation and stress when the end cap is being mounted on the yoke.

According to another alternative which is not illustrated, it may be that a single mounting surface is provided on the yoke, extending from one of the articulation bores on only one of the lateral flanks of the yoke. In such a case, the other lateral flank of the yoke is substantially orthogonal to the central core.

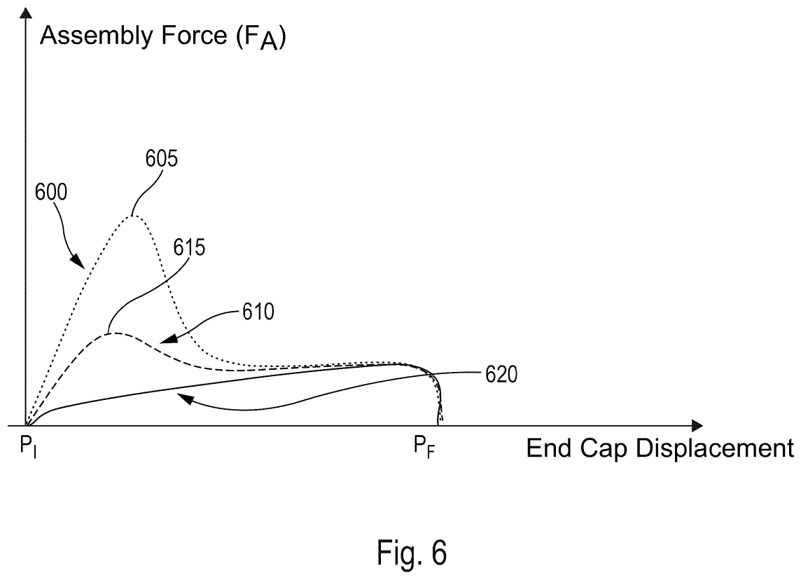

The relative reduction in the assembly force FA that is realized by the embodiment in FIG. 4 and FIG. 5B is illustrated by the graph in FIG. 6. FIG. 6 shows three curves 600, 610, 620, each corresponding to the assembly force FA exerted on the end cap of a windshield wiper during the articulated mounting thereof. The three curves 600, 610, 620 illustrate the assembly force FA plotted against the displacement of the end cap during the articulated mounting thereof on the yoke, from an initial position PI in which the articulation pads come into contact with the yoke but before the cap is deformed, toward its end position PF in which the articulation pads are properly push-fitted in the corresponding articulation bores and the end cap is not deformed in a moved-apart state.

The first curve 600 corresponds to a configuration in which the flanks of the yoke are substantially orthogonal to the central core of the yoke; there is thus no narrowing in the yoke at the articulation bores. This curve thus corresponds to the embodiment illustrated in FIG. 1 to FIG. 3 and FIG. 5A.

It can be seen that this configuration requires an assembly force FA after the start of the displacement of the end cap, which rapidly increases up to the peak 605 and then drops back down to a plateau. The assembly force FA remains substantially constant until the end cap arrives at its end position PF.

The second curve 610 has a configuration in which the angles θ1, θ2 are between 5 and 7 degrees, affording a slight narrowing of the yoke at the articulation of the end cap. Consequently, even though a peak 615 is observed in the assembly force FA, it is greatly reduced in relation to the configuration of the curve 600 without any narrowing at all. After the peak 615, the assembly force decreases to the plateau until the end cap arrives at its end position PF.

It should be understood that the peaks 605 and 615 are the times when the assembly force is at its highest because it is at this time that the sides of the end cap have been moved apart furthest, in order to transfer the articulation pads onto the yoke, and consequently the mechanical stress in the end cap is highest at this point.

It will be realized as a result that the narrowing of this embodiment is advantageous in that it not only reduces the force necessary to mount the end cap in articulation, but also limits the deformation of said cap and therefore the mechanical stress it undergoes during the mounting.

In addition, this fact also makes it possible for the end cap to comprise longer articulation pads than would be possible otherwise, and this makes the articulations of the windshield wiper 2 even more robust.

The third curve 620 has an optimized configuration, in which the angles θ1, θ2 are between 10° and 15°, and preferably are 13°. By contrast to the two preceding curves 600, 610, the third curve 620 exhibits a gentle and progressive rise in the assembly force FA as far as the plateau.

The end cap therefore does not have to be dimensioned to support the mounting forces which rise suddenly to a peak, but can be simply dimensioned to support the plateau. This makes the wiper more lightweight without compromising its strength.

In any case, the optimal values for the angles θ1, θ2, and the mounting forces and the distance between the initial and end positions, in order to afford the assembly force curve which is optimum for the implementation in question will be easily understood by a person skilled in the art.

It will be clearly understood that the invention is not limited to the embodiments presented and other embodiments will be clearly apparent to a person skilled in the art. The disclosure above should be regarded as exemplary and non-limiting.

What is claimed is:

1. A windshield wiper for a vehicle, comprising:
a cowl including a central mount and at least one end cap disposed in the continuation of the central mount;
at least one yoke mounted in pivotable articulation with the central mount,
wherein the at least one end cap is pivotably articulated on the at least one yoke.

2. The wiper as claimed in claim 1, wherein the at least one yoke includes a central core, two lateral flanks extending from opposite edges of the central core and at least one pair of claws at a longitudinal end of at least one yoke.

3. The wiper as claimed in claim 2, wherein the at least one yoke includes at least one articulation bore formed in at least one of the two lateral flanks of the yoke.

4. The wiper as claimed in claim 3, wherein the at least one end cap includes two articulation pads extending top-to-tail from a lower surface of the at least one end cap so as to form an articulation axis, the articulation pads being push-fitted into the at least one articulation bore of the yoke.

5. The wiper as claimed in claim 3, wherein the yoke has a narrowing at certain points of the at least one yoke at the articulation of the end cap on the yoke, the narrowing extending from the at least one articulation bore to the central core of the yoke.

6. The wiper as claimed in claim 5, wherein the at least one narrowing is at least partially formed by at least one mounting surface formed in the yoke, the at least one mounting surface being inclined toward a midplane of the yoke.

7. The wiper as claimed in claim 6, wherein each at least one mounting surface is bordered by at least two guide surfaces, the at least one mounting surface and the at least two guide surfaces together forming a channel, the at least two guide surfaces being substantially planar.

8. The wiper as claimed in claim 7, wherein the channel extends from the articulation bores to the central core of the yoke.

9. The wiper as claimed in claim 5, wherein the at least one narrowing is inclined at an angle ranging between 5 and 20 degrees in relation to the longitudinal midplane of the yoke.

10. A wiping system comprising a windshield wiper, the wiper includes a cowl including a central mount and at least one end cap disposed in the continuation of the central mount, at least one yoke mounted in pivotable articulation with the central mount, wherein the at least one end cap is pivotably articulated on the at least one yoke.

11. The wiper as claimed in claim 5, wherein the at least one narrowing is inclined at an angle ranging between 10 and 15 degrees in relation to the longitudinal midplane of the yoke.

12. The wiper as claimed in claim 5, wherein the at least one narrowing is inclined at 13 degrees in relation to the longitudinal midplane of the yoke.
